(19) United States
(12) Patent Application Publication
(10) Pub. No.: US 2017/0244966 A1
(43) Pub. Date: Aug. 24, 2017

(54) WEIGHTED PREDICTION FOR SCREEN CONTENT CODING AND MULTI-LAYER CODING

(71) Applicant: QUALCOMM Incorporated, San Diego, CA (US)

(72) Inventors: Rajan Laxman Joshi, San Diego, CA (US); Ye-Kui Wang, San Diego, CA (US); Krishnakanth Rapaka, San Diego, CA (US); Marta Karczewicz, San Diego, CA (US)

(21) Appl. No.: 15/434,957

(22) Filed: Feb. 16, 2017

Related U.S. Application Data
(60) Provisional application No. 62/297,858, filed on Feb. 20, 2016.

(51) Int. Cl. H04N 19/126; H04N 19/176; H04N 19/186; H04N 19/593

(52) U.S. Cl. CPC H04N 19/126; H04N 19/593; H04N 19/176; H04N 19/186

(57) ABSTRACT

A device for coding multi-layer video data is configured to determine a picture order count (POC) value for a current picture; determine a POC value for a reference picture; determine a layer identification (ID) value for the current picture; determine a layer ID value for the reference picture; conditionally receive a flag indicating whether weighted prediction is enabled or disabled by receiving the flag in response to at least one of two conditions being true and not receive the flag in response to the two conditions being false, the two conditions being (1) the POC value of the current picture is not equal to the POC value of the reference picture, and (2) the layer ID value for the current picture is not equal to the layer ID value for the reference picture.

This Application claims the benefit of U.S. Provisional Patent Application 62/297,858 filed 20 Feb. 2016, the entire content of which is hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra picture) prediction and/or temporal (inter picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra coded (I) slice of a picture are encoded using spatial prediction with respect to reference samples in neighboring blocks in the same picture. Video blocks in an inter coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter coded block is encoded according to a motion vector that points to a block of reference samples forming the predictive block, and the residual data indicating the difference between the coded block and the predictive block. An intra coded block is encoded according to an intra coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

This disclosure describes techniques that may improve the enabling and disabling of a weighted prediction process, particularly related to its usage in a video coding standard that supports both screen content coding and multi-layer coding.

According to one example of the techniques of this disclosure, a method of decoding multi-layer video data includes determining a picture order count (POC) value for a current picture of the multi-layer video data; determining a POC value for a reference picture of the current picture; determining a layer identification (ID) value for the current picture; determining a layer ID value for the reference picture; conditionally receiving a flag indicating whether weighted prediction is enabled or disabled, wherein conditionally receiving the flag comprises receiving the flag in response to at least one of two conditions being true and not receiving the flag in response to the two conditions being false, the two conditions being (1) the POC value of the current picture is not equal to the POC value of the reference picture, and (2) the layer ID value for the current picture is not equal to the layer ID value for the reference picture; and decoding a block of the multi-layer video data of the current picture based on a determination of whether weighted prediction is enabled or disabled.

In another example of the techniques of this disclosure, a device for decoding multi-layer video data includes a memory configured to store the multi-layer video data and one or more processors configured to determine a picture order count (POC) value for a current picture of the multi-layer video data; determine a POC value for a reference picture of the current picture; determine a layer identification (ID) value for the current picture; determine a layer ID value for the reference picture; conditionally receive a flag indicating whether weighted prediction is enabled or disabled, wherein to conditionally receive the flag the one or more processors are further configured to receive the flag in response to at least one of two conditions being true and not receive the flag in response to the two conditions being false, the two conditions being (1) the POC value of the current picture is not equal to the POC value of the reference picture, and (2) the layer ID value for the current picture is not equal to the layer ID value for the reference picture; and decode a block of the multi-layer video data of the current picture based on a determination of whether weighted prediction is enabled or disabled.

In another example of the techniques of this disclosure, an apparatus for decoding multi-layer video data, the device comprising means for determining a picture order count (POC) value for a current picture of the multi-layer video data; means for determining a POC value for a reference picture of the current picture; means for determining a layer identification (ID) value for the current picture; means for determining a layer ID value for the reference picture; means for conditionally receiving a flag indicating whether weighted prediction is enabled or disabled, wherein the means for conditionally receiving the flag comprises means for receiving the flag in response to at least one of two conditions being true and means for not receiving the flag in response to the two conditions being false, the two conditions being (1) the POC value of the current picture is not equal to the POC value of the reference picture, and (2) the layer ID value for the current picture is not equal to the layer ID value for the reference picture; and means for decoding a block of the multi-layer video data of the current picture based on a determination of whether weighted prediction is enabled or disabled.

In another example of the techniques of this disclosure, a computer readable storage medium storing instructions that when executed by one or more processors cause the one or more processors to determine a picture order count (POC) value for a current picture of the multi-layer video data; determine a POC value for a reference picture of the current picture; determine a layer identification (ID) value for the current picture; determine a layer ID value for the reference picture; conditionally receive a flag indicating whether weighted prediction is enabled or disabled, wherein to conditionally receive the flag the instructions cause the one or more processors to receive the flag in response to at least one of two conditions being true and not receive the flag in response to the two conditions being false, the two conditions being (1) the POC value of the current picture is not equal to the POC value of the reference picture, and (2) the layer ID value for the current picture is not equal to the layer ID value for the reference picture; and decode a block of the multi-layer video data of the current picture based on a determination of whether weighted prediction is enabled or disabled.

In another example of the techniques of this disclosure, a method of encoding multi-layer video data includes determining a picture order count (POC) value for a current picture of the multi-layer video data; determining a POC value for a reference picture of the current picture; determining a layer identification (ID) value for the current picture; determining a layer ID value for the reference picture; conditionally generating, for inclusion in an encoded bitstream of the multi-layer video data, a flag indicating whether weighted prediction is enabled or disabled, wherein conditionally generating the flag comprises generating the flag in response to at least one of two conditions being true and not generating the flag in response to the two conditions being false, the two conditions being (1) the POC value of the current picture is not equal to the POC value of the reference picture, and (2) the layer ID value for the current picture is not equal to the layer ID value for the reference picture; and outputting the encoded bitstream of multi-layer video data.

In another example of the techniques of this disclosure, a device for encoding video data includes a memory configured to store multi-layer video data and one or more processors configured to determine a picture order count (POC) value for a current picture of the multi-layer video data; determine a POC value for a reference picture of the current picture; determine a layer identification (ID) value for the current picture; determine a layer ID value for the reference picture; conditionally generate, for inclusion in an encoded bitstream of the multi-layer video data, a flag indicating whether weighted prediction is enabled or disabled, wherein to conditionally generate the flag the one or more processors are configured to generate the flag in response to at least one of two conditions being true and not generate the flag in response to the two conditions being false, the two conditions being (1) the POC value of the current picture is not equal to the POC value of the reference picture, and (2) the layer ID value for the current picture is not equal to the layer ID value for the reference picture; and output the encoded bitstream of multi-layer video data.

In another example of the techniques of this disclosure, an apparatus for encoding multi-layer video data includes means for determining a picture order count (POC) value for a current picture of the multi-layer video data; means for determining a POC value for a reference picture of the current picture; means for determining a layer identification (ID) value for the current picture; means for determining a layer ID value for the reference picture; means for conditionally generating, for inclusion in an encoded bitstream of the multi-layer video data, a flag indicating whether weighted prediction is enabled or disabled, wherein the means for conditionally generating the flag comprises means for generating the flag in response to at least one of two conditions being true and means for not generating the flag in response to the two conditions being false, the two conditions being (1) the POC value of the current picture is not equal to the POC value of the reference picture, and (2) the layer ID value for the current picture is not equal to the layer ID value for the reference picture; and means for outputting the encoded bitstream of multi-layer video data.

In another example of the techniques of this disclosure, a computer readable storage medium stores instructions that when executed by the one or more processors causes the one or more processors to determine a picture order count (POC) value for a current picture of the multi-layer video data; determine a POC value for a reference picture of the current picture; determine a layer identification (ID) value for the current picture; determine a layer ID value for the reference picture; conditionally generate, for inclusion in an encoded bitstream of the multi-layer video data, a flag indicating whether weighted prediction is enabled or disabled, wherein conditionally generating the flag comprises generating the flag in response to at least one of two conditions being true and not generating the flag in response to the two conditions being false, the two conditions being (1) the POC value of the current picture is not equal to the POC value of the reference picture, and (2) the layer ID value for the current picture is not equal to the layer ID value for the reference picture; and output the encoded bitstream of multi-layer video data

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may utilize the techniques described in this disclosure.

FIG. 2 is a conceptual diagram illustrating example intra block copy (IBC) techniques.

FIG. 3 is a block diagram illustrating an example video encoder that may implement the techniques described in this disclosure.

FIG. 4 is a block diagram illustrating an example video decoder that may implement the techniques described in this disclosure.

FIG. 5 is a flowchart showing a method of decoding video data in accordance with techniques of this disclosure.

FIG. 6 is a flowchart showing a method of encoding video data in accordance with techniques of this disclosure.

### DETAILED DESCRIPTION

Various video coding standards, including the recently developed High Efficiency Video Coding (HEVC) standard, include predictive coding modes for video blocks, where a block currently being coded (i.e., encoded or decoded) is predicted based on an already coded block of video data. In an intra prediction mode, the current block is predicted based on one or more previously coded, neighboring blocks in the same picture as the current block, while in an inter prediction mode the current block is predicted based on an already coded block in a different picture, sometimes referred to as a reference picture. In inter prediction mode, the process of determining a block of a previously coded frame to use as a predictive block is sometimes referred to as motion estimation, which is generally performed by a video encoder, and the process of identifying and retrieving a predictive block is sometimes referred to as motion compensation, which is performed by both video encoders and video decoders.

A video encoder typically determines how to code a sequence of video data by coding the video using multiple coding scenarios (e.g., different combinations of block sizes, coding modes, filtering, etc.) and identifying the coding scenario that produces a desirable rate-distortion tradeoff. When testing intra prediction coding modes for a particular video block, a video encoder typically tests the neighboring row of pixels (i.e. the row of pixels immediately above the block being coded) and tests the neighboring column of pixels (i.e. the column of pixels immediately to the left of the block being coded). In contrast, when testing inter prediction scenarios, the video encoder typically identifies candidate predictive blocks in a much larger search area, where the search area corresponds to video blocks in previously coded frames or pictures of video data.

Inter prediction relies on temporal redundancy in pictures of video. Specifically, a block of video in an already decoded picture may serve as a predictive block for a block in a picture currently being decoded. Inter prediction typically works best (e.g., achieves the best rate-distortion tradeoff) when a block in a current picture closely matches a block in an already decoded picture. Variations in illumination, or other trick effects such as fades, can lessen the coding gains achieved with inter prediction by decreasing the similarity between blocks in a current picture and blocks in already decoded pictures. To improve the coding gains achieved with inter prediction in such situations, HEVC has included a coding tool referred to as weighted prediction. With weighted prediction, multiplicative weighting factor(s) and/or an additive offset(s) are signaled in the bitstream, and based on these parameters, motion compensated prediction is modified.

It has been discovered that for certain types of video images, such as video images that include text, symbols, or repetitive patterns, coding gains can be achieved relative to intra prediction and inter prediction, by using an intra block copy (IBC) mode, which is also sometimes referred to as an intra motion compensation (IMC) mode. In the development of various coding standards, the term IMC mode was originally used, but later modified to IBC mode. The IBC mode is also referred to as “current picture as reference” mode because, in some implementations, IBC modes is implemented as a special case of inter prediction, where the reference picture is the current picture.

In an IBC mode, a video encoder searches for a predictive block in the same frame or picture as the block being coded, as in an intra prediction mode, but the video encoder searches a wider search area and not just the neighboring rows and columns of pixels. In IBC mode, the video encoder may determine an offset vector, also referred to sometimes as a motion vector or block vector, for identifying the predictive block within the same frame or picture as the block being predicted. The offset vector includes, for example, an x-component and a y-component, where the x-component identifies the horizontal displacement between a video block being predicted and the predictive block, and where the y-component identifies a vertical displacement between the video block being predicted and the predictive block. The video encoder signals, in the encoded bitstream, the determined offset vector so that a video decoder, when decoding the encoded bitstream, can identify the same predictive block selected by the video encoder. HEVC includes a screen content coding (SCC) extension that includes IBC and other tools for coding what is commonly referred to as screen content, such as text, symbols, or repetitive patterns.

HEVC and other coding standards also support multi-layer video coding, including both scalable video coding and multi-view video coding. Scalable video coding generally refers to using multiple layers, i.e, a base player plus one or more enhancement layers, to support temporal, SNR, and spatial scalability, while multi-view video coding generally refers to using multiple layers, which may each represent a different view, to support multiple viewpoints and/or three-dimensional effects.

This disclosure describes techniques that may improve the enabling and disabling of a weighted prediction process, particularly related to its usage in a video coding standard that supports both screen content coding and multi-layer coding. Again, with weighted prediction, multiplicative weighting factor(s) and possibly additive offset(s) are signaled in the bitstream, and based on these parameters, motion compensated prediction is modified. The proposed techniques are applicable to screen content coding, multi-layer coding, where for example, one or more of the layers can be coded using the intra block copy tool currently defined in the SCC profile. The techniques of this disclosure may also be used in conjunction with standards or profiles of standards that support high bit depth (more than 8 bit) and/or different chroma sampling format such as 4:4:4, 4:2:2, 4:2:0, 4:0:0.

As will be explained in greater detail below, HEVC and other existing video coding standards utilize the picture order count (POC) values of reference pictures and a current picture to implicitly determine, e.g., without explicit signaling, if weighted prediction is disabled. Such implicit disabling may improve compression efficiency by removing the need to receive certain syntax elements, when such syntax elements are not needed. In the context of multi-layer video coding, however, such existing techniques may disable weighted prediction in coding scenarios where it could be advantageous to utilize weighted prediction. As will be explained in more detail below, the techniques of this disclosure further utilize layer identification values, in conjunction with POC values, for determining when to implicitly disable weighted prediction. The techniques of this disclosure compared to existing techniques may potentially enable weighted prediction for more coding scenarios where weighted prediction potentially produces coding gains while maintaining the benefits of implicitly disabling weighted prediction for some coding scenarios.

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words are merely used to refer to different elements of a same or similar type.

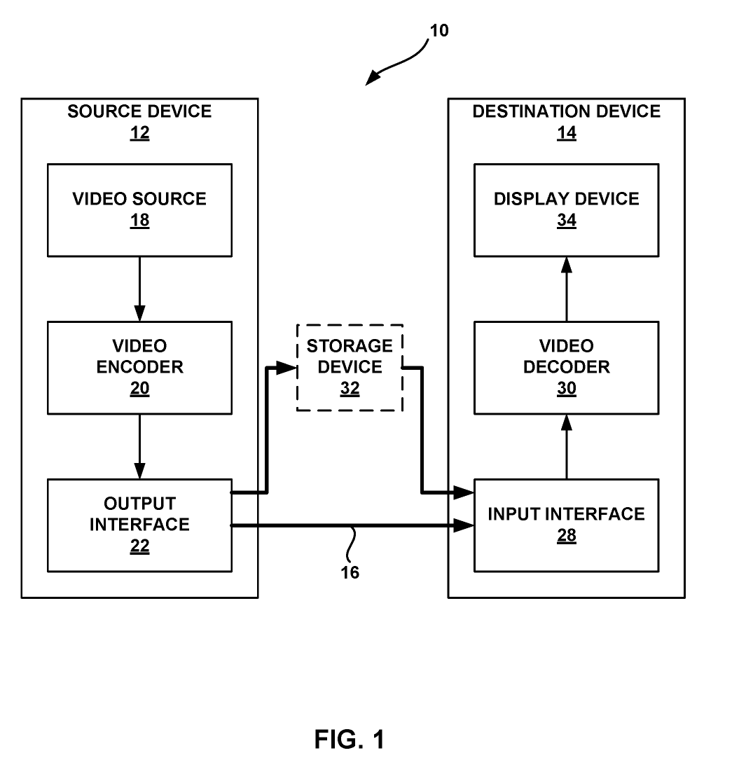

FIG. 1 is a block diagram illustrating an example video encoding and decoding system 10 that may utilize the techniques described in this disclosure, including techniques for coding multi-layer video, for coding blocks in an IBC mode, and for coding blocks using weighted prediction. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 32. Similarly, encoded data may be accessed from storage device 32 by input interface. Storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 32 may correspond to a file server or another intermediate storage device that may hold the encoded video generated by source device 12. Destination device 14 may access stored video data from storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 32 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 32 for later access by destination device 14 or other devices, for decoding and/or playback.

Destination device 14 includes an input interface 28, a video decoder 30, and a display device 34. In some cases, input interface 28 may include a receiver and/or a modem. Input interface 28 of destination device 14 receives the encoded video data over link 16. The encoded video data communicated over link 16, or provided on storage device 32, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 34 may be integrated with, or external to, destination device 14. In some examples, destination device 14 may include an integrated display device and also be configured to interface with an external display device. In other examples, destination device 14 may be a display device. In general, display device 34 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to one or more video coding standards. Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. The latest joint draft of MVC is described in “Advanced video coding for generic audiovisual services,” ITU-T Recommendation H.264, March 2010.

In addition, there is a newly developed video coding standard, HEVC, developed by the Joint Collaboration Team on Video Coding (JCT-VC) of ITU-T Video Coding Experts Group (VCEG) and ISO/IEC Motion Picture Experts Group (MPEG). A recent draft of HEVC is available from phenix.int-evry.fr/jct/doc_end_user/documents/12_Geneva/wg11/JCTVC-L1003-v34.zip. The HEVC standard is also presented jointly in Recommendation ITU-T H.265 and International Standard ISO/IEC 23008-2, both entitled “High efficiency video coding,” and both published October, 2014.

New coding tools for screen-content material such as text and graphics with motion are also presently under development. These new coding tools may be implemented in extensions to HEVC, such as the H.265/HEVC SCC extension. An SCC working draft (SCC WD), JCTVC-U1005, is available at http://phenix.int-evry.fr/jct/doc_end_user/documents/21_Warsaw/wg11/JCTVC-U1005-v1.zip. These new coding tools may also be implemented in successor standards to HEVC.

This disclosure will generally refer to the recently finalized HEVC specification text as HEVC version 1 or base HEVC. The range extension specification may become the version 2 of the HEVC. With respect to many coding tools, such as motion vector prediction, HEVC version 1 and the range extension specification are technically similar. Therefore, whenever this disclosure describes changes relative to HEVC version 1, the same changes may also apply to the range extension specification, which generally includes the base HEVC specification, plus some additional coding tools. Furthermore, it can generally be assumed that HEVC version 1 modules may also be incorporated into a decoder implementing the HEVC range extension.

It is generally contemplated that video encoder 20 of source device 12 may be configured to encode video data according to any of these current or future standards. Similarly, it is also generally contemplated that video decoder 30 of destination device 14 may be configured to decode video data according to any of these current or future standards. Although the techniques described herein will be described with respect to HEVC, the techniques herein may also be compatible with other video coding standards including successor standards to HEVC.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

In HEVC and other video coding specifications, a video sequence typically includes a series of pictures. Pictures may also be referred to as “frames.” A picture may include three sample arrays, denoted S_{L}, S_{Cb}, and S_{Cr}. S_{L} is a two-dimensional array (i.e., a block) of luma samples. Scb is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may comprise a coding tree block of luma samples, two corresponding coding tree blocks of chroma samples, and syntax structures used to code the samples of the coding tree blocks. In monochrome pictures or pictures having three separate color planes, a CTU may comprise a single coding tree block and syntax structures used to code the samples of the coding tree block. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). A slice may include an integer number of CTUs ordered consecutively in a raster scan order.

To generate a coded CTU, video encoder 20 may recursively perform quad-tree partitioning on the coding tree blocks of a CTU to divide the coding tree blocks into coding blocks, hence the name “coding tree units.” A coding block may be an N×N block of samples. A CU may comprise a coding block of luma samples and two corresponding coding blocks of chroma samples of a picture that has a luma sample array, a Cb sample array, and a Cr sample array, and syntax structures used to code the samples of the coding blocks. In monochrome pictures or pictures having three separate color planes, a CU may comprise a single coding block and syntax structures used to code the samples of the coding block.

Video encoder 20 may partition a coding block of a CU into one or more prediction blocks. A prediction block is a rectangular (i.e., square or non-square) block of samples on which the same prediction is applied. A prediction unit (PU) of a CU may comprise a prediction block of luma samples, two corresponding prediction blocks of chroma samples, and syntax structures used to predict the prediction blocks. In monochrome pictures or pictures having three separate color planes, a PU may comprise a single prediction block and syntax structures used to predict the prediction block. Video encoder 20 may generate predictive luma, Cb, and Cr blocks for luma, Cb, and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU. If video encoder 20 uses inter prediction to generate the predictive blocks of a PU, video encoder 20 may generate the predictive blocks of the PU based on decoded samples of one or more pictures other than the picture associated with the PU.

After video encoder 20 generates predictive luma, Cb, and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb, and Cr residual blocks of a CU into one or more luma, Cb, and Cr transform blocks. A transform block is a rectangular (e.g., square or non-square) block of samples on which the same transform is applied. A transform unit (TU) of a CU may comprise a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. After video encoder 20 quantizes a coefficient block, video encoder 20 may entropy encode syntax elements indicating the quantized transform coefficients. For example, video encoder 20 may perform Context-Adaptive Binary Arithmetic Coding (CABAC) on the syntax elements indicating the quantized transform coefficients.

Video encoder 20 may output a bitstream that includes a sequence of bits that forms a representation of coded pictures and associated data. The bitstream may comprise a sequence of NAL units. A NAL unit is a syntax structure containing an indication of the type of data in the NAL unit and bytes containing that data in the form of a RB SP interspersed as necessary with emulation prevention bits. Each of the NAL units includes a NAL unit header and encapsulates a RBSP. The NAL unit header may include a syntax element that indicates a NAL unit type code. The NAL unit type code specified by the NAL unit header of a NAL unit indicates the type of the NAL unit. A RB SP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate an RBSP for a PPS, a second type of NAL unit may encapsulate an RBSP for a coded slice, a third type of NAL unit may encapsulate an RBSP for SEI messages, and so on. NAL units that encapsulate RBSPs for video coding data (as opposed to RBSPs for parameter sets and SEI messages) may be referred to as VCL NAL units.

Video decoder 30 may receive a bitstream generated by video encoder 20. In addition, video decoder 30 may parse the bitstream to obtain syntax elements from the bitstream. Video decoder 30 may reconstruct the pictures of the video data based at least in part on the syntax elements obtained from the bitstream. The process to reconstruct the video data may be generally reciprocal to the process performed by video encoder 20. In addition, video decoder 30 may inverse quantize coefficient blocks associated with TUs of a current CU. Video decoder 30 may perform inverse transforms on the coefficient blocks to reconstruct transform blocks associated with the TUs of the current CU. Video decoder 30 may reconstruct the coding blocks of the current CU by adding the samples of the predictive blocks for PUs of the current CU to corresponding samples of the transform blocks of the TUs of the current CU. By reconstructing the coding blocks for each CU of a picture, video decoder 30 may reconstruct the picture.

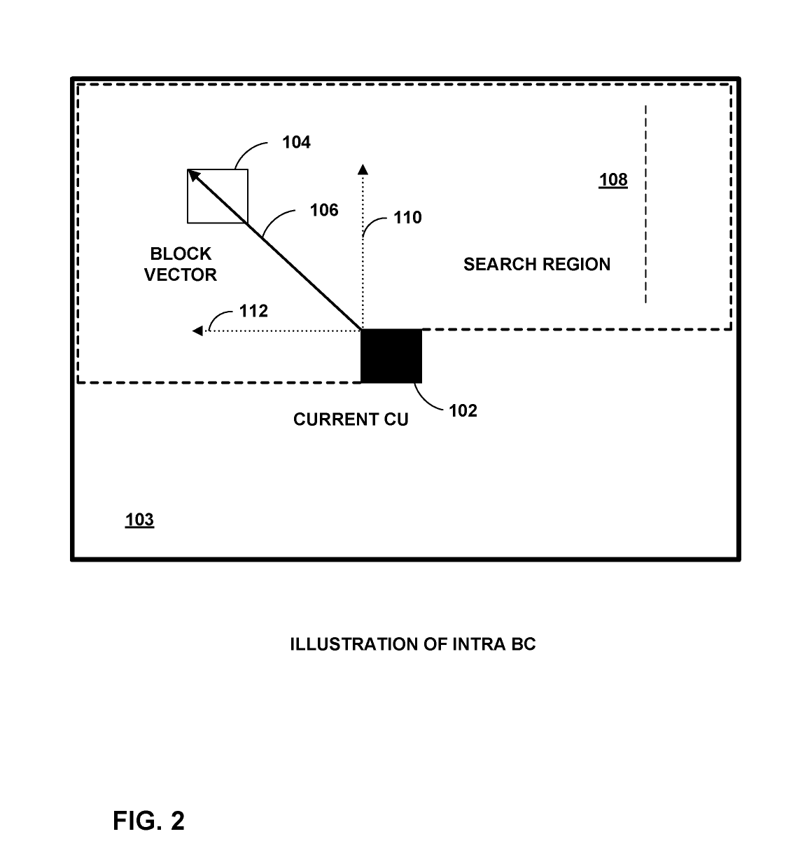

FIG. 2 shows a conceptual illustration of the IBC mode. Video encoder 20 and video decoder 30 may, for example be configured to encode and decode blocks of video data using an IBC mode. Many applications, such as remote desktop, remote gaming, wireless displays, automotive infotainment, cloud computing, etc., are becoming routine in people's daily lives, and the coding efficiency when coding such content may be improved by the use of an IBC mode. System 10 of FIG. 1 may represent devices configured to execute any of these applications. Video content in these applications are often combinations of natural content, text, artificial graphics, etc. In text and artificial graphics regions of video frames, repeated patterns (such as characters, icons, symbols, etc.) often exist. As introduced above, IBC is a dedicated technique which enables removing this kind of redundancy and potentially improving the intra-frame coding efficiency as reported in JCT-VC M0350. As illustrated in FIG. 2, for the CUs which use IBC, the prediction signals are obtained from the already reconstructed region in the same frame. In the end, the offset vector, which indicates the position of the prediction signal displaced from the current CU, together with the residue signal are encoded.

For instance, FIG. 2 illustrates an example technique for predicting a current block 102 of video data within a current picture 103 according to a mode for intra prediction of blocks of video data from predictive blocks of video data within the same picture according to this disclosure, e.g., according to an IBC mode in accordance with the techniques of this disclosure. FIG. 2 illustrates a predictive block of video data 104 within current picture 103. A video coder, e.g., video encoder 20 and/or video decoder 30, may use predictive video block 104 to predict current video block 102 according to an IBC mode in accordance with the techniques of this disclosure.

Video encoder 20 selects predictive video block 104 for predicting current video block 102 from a set of previously reconstructed blocks of video data. Video encoder 20 reconstructs blocks of video data by inverse quantizing and inverse transforming the video data that is also included in the encoded video bitstream, and summing the resulting residual blocks with the predictive blocks used to predict the reconstructed blocks of video data. In the example of FIG. 2, intended region 108 within picture 103, which may also be referred to as an “intended area” or “raster area,” includes the set of previously reconstructed video blocks. Video encoder 20 may define intended region 108 within picture 103 in variety of ways, as described in greater detail below. Video encoder 20 may select predictive video block 104 to predict current video block 102 from among the video blocks in intended region 108 based on an analysis of the relative efficiency and accuracy of predicting and coding current video block 102 based on various video blocks within intended region 108.

Intended region 108 may also be referred to in this disclosure as an IBC prediction region. This disclosure describes various techniques that may modify what blocks are included in intended region 108. Thus, when implementing the techniques of this disclosure, the size and shape of intended region 108 may be different than that shown in the example of FIG. 2.

Video encoder 20 determines two-dimensional vector 106 representing the location or displacement of predictive video block 104 relative to current video block 102. Two-dimensional vector 106, which is an example of an offset vector, includes horizontal displacement component 112 and vertical displacement component 110, which respectively represent the horizontal and vertical displacement of predictive video block 104 relative to current video block 102. Video encoder 20 may include one or more syntax elements that identify or define two-dimensional vector 106, e.g., that define horizontal displacement component 112 and vertical displacement component 110, in the encoded video bitstream. Video decoder 30 may decode the one or more syntax elements to determine two-dimensional vector 106, and use the determined vector to identify predictive video block 104 for current video block 102.

Current video block 102 may be a CU, or a PU of a CU. In some examples, a video coder, e.g., video encoder 20 and/or video decoder 30, may split a CU that is predicted according to IBC into a number of PUs. In such examples, the video coder may determine a respective (e.g., different) two-dimensional vector 106 for each of the PUs of the CU. For example, a video coder may split a 2N×2N CU into two 2N×N PUs, two N×2N PUs, or four N×N PUs. As other examples, a video coder may split a 2N×2N CU into ((N/2)×N+(3N/2)×N) PUs, ((3N/2)×N+(N/2)×N) PUs, (N×(N/2)+N×(3N/2)) PUs, (N×(3N/2)+N×(N/2)) PUs, four (N/2)×2N PUs, or four 2N×(N/2) PUs. In some examples, video coder may predict a 2N×2N CU using a 2N×2N PU.

Current video block 102 includes a luma video block (e.g., luma component) and a chroma video block (e.g., chroma component) corresponding to the luma video block. In some examples, video encoder 20 may only encode one or more syntax elements defining two-dimensional vectors 106 for luma video blocks into the encoded video bitstream. In such examples, video decoder 30 may derive two-dimensional vectors 106 for each of one or more chroma blocks corresponding to a luma block based on the two-dimensional vector signaled for the luma block. In the techniques described in this disclosure, in the derivation of the two-dimensional vectors for the one or more chroma blocks, video decoder 30 may modify the two-dimensional vector for the luma block if the two-dimensional vector for the luma block points to a sub-pixel position within the chroma sample.

Depending on the color format, e.g., color sampling format or chroma sampling format, a video coder may downsample corresponding chroma video blocks relative to the luma video block. Color format 4:4:4 does not include downsampling, meaning that the chroma blocks include the same number of samples in the horizontal and vertical directions as the luma block. Color format 4:2:2 is downsampled in the horizontal direction, meaning that there are half as many samples in the horizontal direction in the chroma blocks relative to the luma block. Color format 4:2:0 is downsampled in the horizontal and vertical directions, meaning that there are half as many samples in the horizontal and vertical directions in the chroma blocks relative to the luma block.

In examples in which video coders determine vectors 106 for chroma video blocks based on vectors 106 for corresponding luma blocks, the video coders may need to modify the luma vector. For example, if a luma vector 106 has integer resolution with horizontal displacement component 112 and/or vertical displacement component 110 being an odd number of pixels, and the color format is 4:2:2 or 4:2:0, the converted luma vector may not point an integer pixel location in the corresponding chroma block. In such examples, video coders may scale the luma vector for use as a chroma vector to predict a corresponding chroma block.

FIG. 2 shows a current CU that is being coded in an IBC mode. A predictive block for the current CU may be obtained from the search region. The search region includes already coded blocks from the same frame as the current CU. Assuming, for example, the frame is being coded in a raster scan order (i.e. left-to-right and top-to-bottom), the already coded blocks of the frame correspond to blocks that are to the left of and above the current CU, as shown in FIG. 2. In some examples, the search region may include all of the already coded blocks in the frame, while in other examples, the search region may include fewer than all of the already coded blocks. The offset vector in FIG. 2, sometimes referred to as a motion vector or prediction vector, identifies the differences between a top-left pixel of the current CU and a top-left pixel of the predictive block (labeled prediction signal in FIG. 2). Thus, by signaling the offset vector in the encoded video bitstream, a video decoder can identify the predictive block for the current CU, when the current CU is coded in an IBC mode.

IBC has been included in various implementations of SCC, including the SCC extension to HEVC. An example of IBC is described above with respect to FIG. 2, where the current CU/PU is predicted from an already decoded block of the current picture/slice. In IBC, a predictive block (e.g. block 104 in FIG. 2) may be a reconstructed block that has not been loop filtered, e.g. has not been deblock filtered or SAO filtered.

In some implementations of SCC, the block vector predictor is set to (−w, 0) at the beginning of each CTB, where w corresponds to the width of the CU. Such a block vector predictor is updated to be the one of the latest coded CU/PU if that is coded with IBC mode. If a CU/PU is not coded with IBC, then the block vector predictor remains unchanged. After block vector prediction, the block vector difference is encoded using a MV difference (MVD) coding method such as in HEVC.

Some implementations of IBC enable IBC coding at both CU and PU levels. For PU level IBC, 2N×N and N×2N PU partitions are supported for all the CU sizes. In addition, when the CU is the smallest CU, N×N PU partition is supported.

In the HEVC SCC specification (JCTVC-W1005-v4), the Intra BC signalling is unified with inter by adding the current picture to the reference candidate set. Before the decoding of current slice, the current picture is marked as long-term. Then, it is converted back to short-term after the decoding of current picture. The signalling and coding methods, including merge/AMVP signalling, AMVP derivation and MVD coding, are the same as inter. However, the Intra BC block can be differentiated from the conventional inter blocks by checking the corresponding reference picture. If the reference picture is the current picture, then it is an Intra BC block. Otherwise, it is an inter block. In case of bi-directional prediction, this interpretation may be applied to each motion vector.

POC values may be used in video coding standards to identify a picture. POC values of pictures are used for the construction of reference picture set and reference picture list, for motion vector (MV) scaling, and for determination of the order of outputting decoded pictures. HEVC defines picture order count as follows:
picture order count: A variable that is associated with each picture, uniquely identifies the associated picture among all pictures in the CVS, and, when the associated picture is to be output from the decoded picture buffer, indicates the position of the associated picture in output order relative to the output order positions of the other pictures in the same CVS that are to be output from the decoded picture buffer.

As per the current SCC working draft (JCTVC-W1005-v4), the weighted prediction is disabled when reference picture POC is same as the current picture POC. Consequently, to avoid signalling of useless information, as shown in the syntax table below, based on the POC of the reference picture and the current picture (underlined in Table 1 below) some weighted prediction info such as luma_weight_l0_flag, chroma_weight_l0_flag, luma_weight_l1_flag_chroma_weight_l1_flag is not signalled.

TABLE 1

| pred_weight_table( ) { | Descriptor |
|---|---|
| luma_log2_weight_denom | ue(v) |
| if( ChromaArrayType != 0 ) | |
| delta_chroma_log2_weight_denom | se(v) |
| for( i = 0; i <= num_ref_idx_l0_active_minus1; i++ ) | |
| if( PicOrderCnt( RefPicList0[ i ] ) != PicOrderCnt( CurrPic ) ) | |
| luma_weight_l0_flag[ i ] | u(1) |
| if( ChromaArrayType != 0 ) | |
| for( i = 0; i <= num_ref_idx_l0_active_minus1; i++ ) | |
| if( PicOrderCnt(RefPicList0[ i ]) != PicOrderCnt( CurrPic ) ) | |
| chroma_weight_l0_flag[ i ] | u(1) |
| for( i = 0; i <= num_ref_idx_l0_active_minus1; i++ ) { | |
| if( luma_weight_l0_flag[ i ] ) { | |
| delta_luma_weight_l0[ i ] | se(v) |
| luma_offset_l0[ i ] | se(v) |
| } | |
| if( chroma_weight_l0_flag[ i ] ) | |
| for( j = 0; j < 2; j++ ) { | |
| delta_chroma_weight_l0[ i ][ j ] | se(v) |
| delta_chroma_offset_l0[ i ][ j ] | se(v) |
| } | |
| } | |
| if( slice_type == B ) { | |
| for( i = 0; i <= num_ref_idx_l1_active_minus1; i++ ) | |
| if( PicOrderCnt(RefPicList1[ i ]) != PicOrderCnt( CurrPic ) ) | |
| luma_weight_l1_flag[ i ] | u(1) |
| if( ChromaArrayType != 0 ) | |
| for( i = 0; i <= num_ref_idx_l1_active_minus1; i++ ) | |
| if( PicOrderCnt(RefPicList1[ i ]) != PicOrderCnt( CurrPic ) ) | |
| chroma_weight_l1_flag[ i ] | u(1) |
| for( i = 0; i <= num_ref_idx_l1_active_minus1; i++ ) { | |
| if( luma_weight_l1_flag[ i ] ) { | |
| delta_luma_weight_l1[ i ] | se(v) |
| luma_offset_l1[ i ] | se(v) |
| } | |
| if( chroma_weight_l1_flag[ i ] ) | |
| for( j = 0; j < 2; j++ ) { | |
| delta_chroma_weight_l1[ i ][ j ] | se(v) |
| delta_chroma_offset_l1[ i ][ j ] | se(v) |
| } | |
| } | |
| } | |
| } | |

When multi-layer coding is used, a picture from a different layer may have the same POC as the current picture being decoded. Thus, according to the current syntax, when the reference picture is from a different layer but with the same POC as the current picture, weighted prediction is implicitly disabled as no weighted prediction parameters are signalled. This can result in performance degradation due to weighted prediction being disabled for a coding scenario where weighted prediction could potentially produce coding gains.

JCTVC-W0076 proposes a solution to this problem by introducing a check on whether the PPS level IBC flag is 1 as follows:

TABLE 2

| pred_weight_table( ) { | Descriptor |
|---|---|
| luma_log2_weight_denom | ue(v) |
| if( ChromaArrayType != 0 ) | |
| delta_chroma_log2_weight_denom | se(v) |
| for( i = 0; i <= num_ref_idx_l0_active_minus1; i++ ) | |
| if(pps_curr_pic_ref_enabled_flag && | |
| PicOrderCnt( RefPicList0[ i ] ) != PicOrderCnt( CurrPic ) ) | |
| luma_weight_l0_flag[ i ] | u(1) |
| if( ChromaArrayType != 0 ) | |
| for( i = 0; i <= num_ref_idx_l0_active_minus1; | |
| i++ ) | |
| if(pps_curr_pic_ref_enabled_flag && | |
| PicOrderCnt(RefPicList0[ i ]) != PicOrderCnt( CurrPic ) ) | |
| chroma_weight_l0_flag[ i ] | u(1) |
| for( i = 0; i <= num_ref_idx_l0_active_minus1; i++ ) { | |
| if( luma_weight_l0_flag[ i ] ) { | |
| delta_luma_weight_l0[ i ] | se(v) |
| luma_offset_l0[ i ] | se(v) |
| } | |
| if( chroma_weight_l0_flag[ i ] ) | |
| for( j = 0; j < 2; j++ ) { | |
| delta_chroma_weight_l0[ i ][ j ] | se(v) |
| delta_chroma_offset_l0[ i ][ j ] | se(v) |
| } | |
| } | |
| if( slice_type == B ) { | |
| for( i = 0; i <= num_ref_idx_l1_active_minus1; | |
| i++ ) | |
| if(pps_curr_pic_ref_enabled_flag && | |
| PicOrderCnt(RefPicList1[ i ]) != PicOrderCnt( CurrPic ) ) | |
| luma_weight_l1_flag[ i ] | u(1) |
| if( ChromaArrayType != 0 ) | |
| for( i = 0; i <= num_ref_idx_l1_active_minus1; | |
| i++ ) | |
| if(pps_curr_pic_ref_enabled_flag && | |
| PicOrderCnt(RefPicList1[ i ]) != | |
| PicOrderCnt( CurrPic ) ) | |
| chroma_weight_l1_flag[ i ] | u(1) |
| for( i = 0; i <= num_ref_idx_l1_active_minus1; | |
| i++ ) { | |
| if( luma_weight_l1_flag[ i ] ) { | |
| delta_luma_weight_l1[ i ] | se(v) |
| luma_offset_l1[ i ] | se(v) |
| } | |
| if( chroma_weight_l1_flag[ i ] ) | |
| for( j = 0; j < 2; j++ ) { | |
| delta_chroma_weight_l1[ i ][ j ] | se(v) |
| delta_chroma_offset_l1[ i ][ j ] | se(v) |
| } | |
| } | |
| } | |
| } | |

However, this proposal does not solve the problem. For example, a future profile or video coding standard may combine SCC tools with multi-layer coding. In such a case, whenever the PPS level IBC flag is equal to 1 for a picture, weighted prediction would be disabled even when the reference picture is from another layer and with the same POC as the current picture, a coding scenario where it might be desirable to enable weighted prediction for the inter-layer prediction for improved coding performance. The techniques of this disclosure introduce a potential solution to address the problems described above.

According to the techniques of this disclosure, some weighted prediction information such as luma_weight_l0_flag, chroma_weight_l0_flag, luma_weight_l1_flag_chroma_weight_l1_flag may be conditionally signalled based on (a) POC values of a reference and a current picture and (b) values of nuh_layer_id for a reference picture and a current picture. That is to say, the signaling of weighted prediction information may be signaled in some cases, but such signaling may be purposely skipped in other cases. The decision whether to signal or skip the signaling of the weighted preidtion information may be based on a POC of a reference picture, a POC of a current picture, a nuh_layer_id of a reference picture and a nuh_layer_id of a current picture.

The parameters luma_weight_l0_flag, chroma_weight_l0_flag, luma_weight_l1_flag_chroma_weight_l1_flag are signalled conditionally if one or both the following conditions are not true (in other words, weighted prediction is disabled and the weighted prediction parameters are not signalled only when both of the following conditions are true):
The POC values of the reference picture and the current picture are the same
The nuh_layer_id values of the reference picture and the current picture are the same.

The text modifications are shown in Table 3 below, where the function LayerIdVal(picX) is specified as follows:

LayerIdVal(picX)=nuh_layer_id of the picture picX

TABLE 3

| pred_weight_table( ) { | Descriptor |
|---|---|
| luma_log2_weight_denom | ue(v) |
| if( ChromaArrayType != 0 ) | |
| delta_chroma_log2_weight_denom | se(v) |
| for( i = 0; i <= num_ref_idx_l0_active_minus1; i++ ) | |
| if( PicOrderCnt( RefPicList0[ i ] ) != PicOrderCnt( CurrPic ) \|\| | |
| ( LayerIdVal( RefPicList0[ i ] ) != LayerIdVal( CurrPic ) ) | |
| luma_weight_l0_flag[ i ] | u(1) |
| if( ChromaArrayType != 0 ) | |
| for( i = 0; i <= num_ref_idx_l0_active_minus1; i++ ) | |
| if( PicOrderCnt( RefPicList0[ i ] ) != PicOrderCnt( CurrPic ) \|\| | |
| ( LayerIdVal( RefPicList0[ i ] ) != LayerIdVal( CurrPic ) ) | |
| chroma_weight_l0_flag[ i ] | u(1) |
| for( i = 0; i <= num_ref_idx_l0_active_minus1; i++ ) { | |
| if( luma_weight_l0_flag[ i ] ) { | |
| delta_luma_weight_l0[ i ] | se(v) |
| luma_offset_l0[ i ] | se(v) |
| } | |
| if( chroma_weight_l0_flag[ i ] ) | |
| for( j = 0; j < 2; j++ ) { | |
| delta_chroma_weight_l0[ i ][ j ] | se(v) |
| delta_chroma_offset_l0[ i ][ j ] | se(v) |
| } | |
| } | |
| if( slice_type == B ) { | |
| for( i = 0; i <= num_ref_idx_l1_active_minus1; i++ ) | |
| if( PicOrderCnt( RefPicList1[ i ] ) != PicOrderCnt( CurrPic ) \|\| | |
| ( LayerIdVal( RefPicList1[ i ] ) != LayerIdVal( CurrPic ) ) | |
| luma_weight_l1_flag[ i ] | u(1) |
| if( ChromaArrayType != 0 ) | |
| for( i = 0; i <= num_ref_idx_l1_active_minus1; i++ ) | |
| if( PicOrderCnt( RefPicList1[ i ] ) != PicOrderCnt( CurrPic ) \|\| | |
| ( LayerIdVal( RefPicList1[ i ] ) != LayerIdVal( CurrPic ) ) | |
| chroma_weight_l1_flag[ i ] | u(1) |
| for( i = 0; i <= num_ref_idx_l1_active_minus1; i++ ) { | |
| if( luma_weight_l1_flag[ i ] ) { | |
| delta_luma_weight_l1[ i ] | se(v) |
| luma_offset_l1[ i ] | se(v) |
| } | |
| if( chroma_weight_l1_flag[ i ] ) | |
| for( j = 0; j < 2; j++ ) { | |
| delta_chroma_weight_l1[ i ][ j ] | se(v) |
| delta_chroma_offset_l1[ i ][ j ] | se(v) |
| } | |
| } | |
| } | |
| } | |

Each of the syntax elements luma_weight_l0_flag, chroma_weight_l0_flag, luma_weight_l1_flag_chroma_weight_l1_flag are signalled conditionally, with the syntax element being received if at least one of two conditions are true and not received if both of the two conditions are false. The first conditions is the POC value of the current picture is not equal to the POC value of the reference picture, which is shown in Table 3 above as:

PicOrderCnt(RefPicList0[i])!=PicOrderCnt(CurrPic); and

PicOrderCnt(RefPicList1[i])!=PicOrderCnt(CurrPic).

The second condition is the layer ID value for the current picture is not equal to the layer ID value for the reference picture, which is shown in Table 3 above as:

LayerIdVal(RefPicList0[i])!=LayerIdVal(CurrPic); and

LayerIdVal(RefPicList1[i])!=LayerIdVal(CurrPic).

The pred_weight_table syntax structure described above with respect to Tables 1-3 may, for example, be implemented as part of a slice header or other such syntax structure. According to section 7.4.7.3 of HEVC, the syntax elements of Tables 1-3 are defined as follows. The syntax element “luma_log2_weight_denom” is the base 2 logarithm of the denominator for all luma weighting factors. The value of luma_log2_weight_denom shall be in the range of 0 to 7, inclusive. The syntax element “delta_chroma_log2_weight_denom” is the difference of the base 2 logarithm of the denominator for all chroma weighting factors. The syntax element “luma_weight_l0_flag[i]” set equal to 1 specifies that weighting factors for the luma component of list 0 prediction using RefPicList0[i] are present. luma_weight_l0_flag[i] equal to 0 specifies that these weighting factors are not present. The syntax element “chroma_weight_l0_flag[i]” set equal to 1 specifies that weighting factors for the chroma prediction values of list 0 prediction using RefPicList0[i] are present. chroma_weight_l0_flag[i] equal to 0 specifies that these weighting factors are not present. When chroma_weight_l0_flag[i] is not present, it is inferred to be equal to 0. The syntax element “delta_luma_weight_l0[i]” is the difference of the weighting factor applied to the luma prediction value for list 0 prediction using RefPicList0[i].

The syntax element “luma_offset_l0[i]” is the additive offset applied to the luma prediction value for list 0 prediction using RefPicList0[i]. The value of luma_offset_l0[i] shall be in the range of −128 to 127, inclusive. When luma_weight_l0_flag[i] is equal to 0, luma_offset_l0[i] is inferred as equal to 0. The syntax element “delta_chroma_weight_l0[i][j]” is the difference of the weighting factor applied to the chroma prediction values for list 0 prediction using RefPicList0[i] with j equal to 0 for Cb and j equal to 1 for Cr. The syntax element “delta_chroma_offset_l0[i][j]” is the difference of the additive offset applied to the chroma prediction values for list 0 prediction using RefPicList0[i] with j equal to 0 for Cb and j equal to 1 for Cr.

Furthermore, according to section 7.4.7.3 of HEVC the syntax elements luma_weight_l1_flag[i], chroma_weight_l1_flag[i], delta_luma_weight_l1[i], luma_offset_l1[i], delta_chroma_weight_l1[i][j], and delta_chroma_offset_l1[i][j] have the same semantics as luma_weight_l0_flag[i], chroma_weight_l0_flag[i], delta_luma_weight_l0[i], luma_offset_l0[i], delta_chroma_weight_l0[i][j], and delta_chroma_offset_l0[i][j], respectively, with l0, L0, list 0, and List0 replaced by l1, L1, list 1, and List1, respectively.

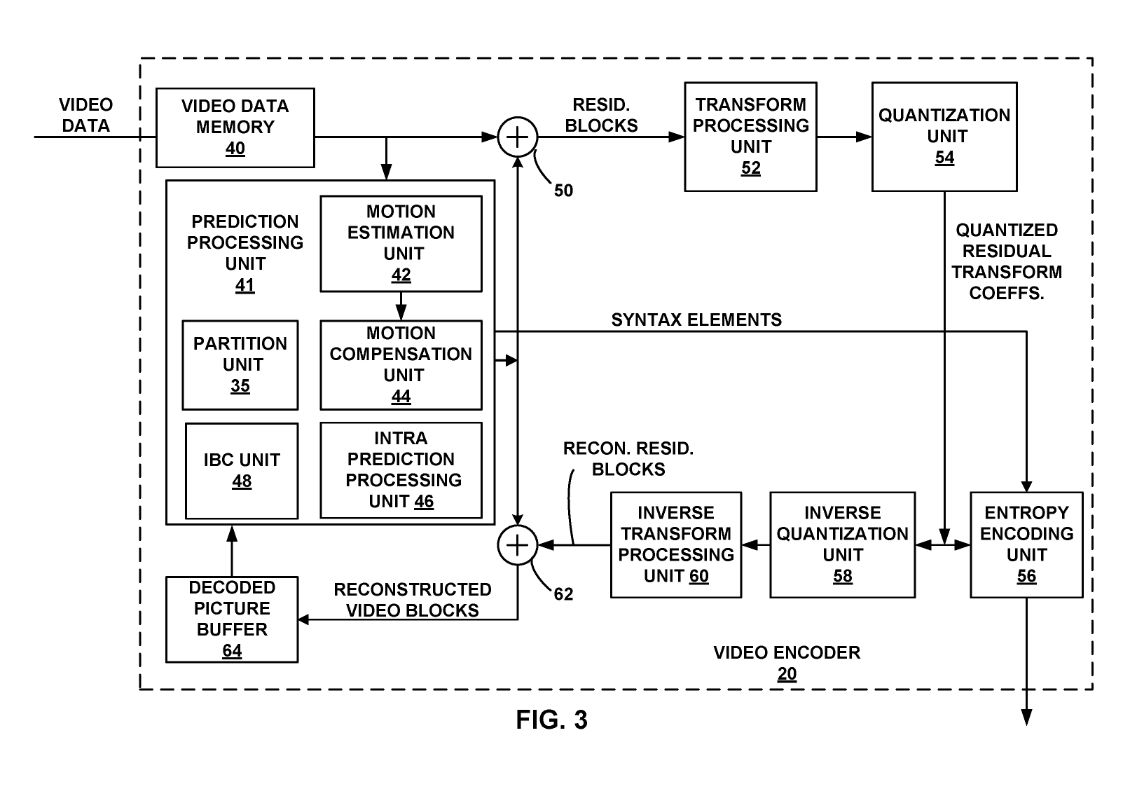

FIG. 3 is a block diagram illustrating an example video encoder 20 that may implement the IBC coding techniques described in this disclosure. Video encoder 20 may perform intra and inter coding of video blocks within video slices. Intra coding relies on spatial prediction to reduce or remove spatial redundancy in video within a given video frame or picture. Inter coding relies on temporal prediction to reduce or remove temporal redundancy in video within adjacent frames or pictures of a video sequence. Intra mode (I mode) may refer to any of several spatial based compression modes.

In the example of FIG. 3, video encoder 20 includes video data memory 40, prediction processing unit 41, decoded picture buffer 64, summer 50, transform processing unit 52, quantization unit 54, and entropy encoding unit 56. Prediction processing unit 41 includes partition unit 35, motion estimation unit 42, motion compensation unit 44, IBC unit 48, and intra prediction processing unit 46. For video block reconstruction, video encoder 20 also includes inverse quantization unit 58, inverse transform processing unit 60, and summer 62. An in-loop filter (not pictured) may be positioned between summer 62 and decoded picture buffer 64.

In various examples, a fixed or programmable hardware unit of video encoder 20 may be tasked to perform the techniques of this disclosure. Also, in some examples, the techniques of this disclosure may be divided among one or more of the illustrated fixed or programmable hardware units of video encoder 20 shown in FIG. 3, though other devices may also perform the techniques of this disclosure. For example, consistent with the example of FIG. 3, motion compensation unit 44 of video encoder 20 may perform some of the techniques of this disclosure, alone, or in combination with other units of video encoder 20, such as motion estimation unit 42, IBC unit 48, and entropy encoding unit 56. In some examples, video encoder 20 may not include a dedicated IBC unit 48, and instead, the functionality of IBC unit 48 may be performed by other components of prediction processing unit 41, such as motion estimation unit 42 and/or motion compensation unit 44.

Video data memory 40 may store video data to be encoded by the components of video encoder 20. The video data stored in video data memory 40 may be obtained, for example, from video source 18. Decoded picture buffer (DPB) 64 is a buffer that stores reference video data for use in encoding video data by video encoder 20 (e.g., in intra or inter coding modes, also referred to as intra or inter prediction coding modes). Video data memory 40 and DPB 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 40 and DPB 64 may be provided by the same memory device or separate memory devices. In various examples, video data memory 40 may be on-chip with other components of video encoder 20, or off-chip relative to those components.

As shown in FIG. 3, video encoder 20 receives video data, and partition unit 35 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may be configured to implement the techniques of this disclosure described above for encoding in IBC mode. Prediction processing unit 41 may provide the resulting intra or inter coded block to summer 50 to generate residual block data and to summer 62 to reconstruct the encoded block for use as a reference picture.

Intra prediction processing unit 46 within prediction processing unit 41 may perform intra predictive coding of the current video block relative to one or more neighboring blocks in the same frame or slice as the current block to be coded to provide spatial compression. Motion estimation unit 42 and motion compensation unit 44 within prediction processing unit 41 perform inter predictive coding of the current video block relative to one or more predictive blocks in one or more reference pictures to provide temporal compression.

Motion estimation unit 42 may be configured to determine the inter prediction mode for a video slice according to a predetermined pattern for a video sequence. The predetermined pattern may designate video slices in the sequence as P slices or B slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture. IBC unit 48 may determine vectors, e.g., block vectors, for IBC coding in a manner similar to the determination of motion vectors by motion estimation unit 42 for inter prediction, or may utilize motion estimation unit 42 to determine the block vector.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in decoded picture buffer 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter coded slice by comparing the position of the PU to the position of a predictive block of a reference picture. The reference picture may be selected from a first reference picture list (List 0) or a second reference picture list (List 1), each of which identify one or more reference pictures stored in decoded picture buffer 64. Motion estimation unit 42 sends the calculated motion vector to entropy encoding unit 56 and motion compensation unit 44. As part of determining reference blocks in reference pictures, motion estimation unit 42 may also perform weighted prediction.

In some examples, IBC unit 48 may generate vectors and fetch predictive blocks in a manner similar to that described above with respect to motion estimation unit 42 and motion compensation unit 44, but with the predictive blocks being in the same picture or frame as the current block and with the vectors being referred to as block vectors as opposed to motion vectors. In other examples, IBC unit 48 may use motion estimation unit 42 and motion compensation unit 44, in whole or in part, to perform such functions for IBC prediction according to the techniques described herein. In either case, for IBC, a predictive block may be a block that is found to closely match the block to be coded, in terms of pixel difference, which may be determined by sum of absolute difference (SAD), sum of squared difference (SSD), or other difference metrics, and identification of the block may include calculation of values for sub-integer pixel positions.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

As introduced above, when coding a block in an inter prediction mode, prediction processing unit may signal the motion information using a merge mode. For example, for a current block of a current picture, motion estimation unit 42 and/or IBC unit 48 may generate a merge candidate list, with each candidate in the merge candidate list having associated motion information. The motion information may include motion vectors that point to the same picture as the current block or a previously coded picture. Motion estimation unit 42 and/or IBC unit 48 may select a merge candidate from the merge candidate list and encode the current block using the motion information of the selected candidate. Prediction processing unit 41 may output, to entropy encoding unit 56, a syntax element identifying the selected merge candidate. Entropy encoding unit 56 may entropy encode the syntax element for inclusion in the encoded bitstream.

Whether the predictive video block is from the same picture according to IBC prediction, or a different picture according to inter prediction, video encoder 20 may form a residual video block by subtracting pixel values of the predictive block from the pixel values of the current video block being coded, forming pixel difference values. The pixel difference values form residual data for the block, and may include both luma component differences and chroma component differences. Summer 50 represents the component or components that perform this subtraction operation. IBC unit 48 and/or motion compensation unit 44 may also generate syntax elements associated with the video blocks and the video slice for use by a video decoder, such as video decoder 30, in decoding the video blocks of the video slice. The syntax elements may include, for example, syntax elements defining the vector used to identify the predictive block, any flags indicating the prediction mode, or any other syntax described with respect to the techniques of this disclosure.

Intra prediction processing unit 46 may intra-predict a current block, as an alternative to the inter-prediction performed by motion estimation unit 42 and motion compensation unit 44, or the IBC prediction performed by IBC unit 48, as described above. In particular, intra prediction processing unit 46 may determine an intra prediction mode, including an IBC mode, to use to encode a current block. In some examples, intra prediction processing unit 46 may encode a current block using various intra prediction modes, e.g., during separate encoding passes, and intra prediction processing unit 46 (or a mode select unit, in some examples) may select an appropriate intra prediction mode to use from the tested modes.

For example, intra prediction processing unit 46 may calculate rate-distortion values using a rate-distortion analysis for the various tested intra prediction modes, and select the intra prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra prediction processing unit 46 may calculate ratios from the distortions and rates for the various encoded blocks to determine which intra prediction mode exhibits the best rate-distortion value for the block.

In any case, after selecting an intra prediction mode for a block, intra prediction processing unit 46 may provide information indicative of the selected intra prediction mode for the block to entropy encoding unit 56. Entropy encoding unit 56 may encode the information indicating the selected intra prediction mode in accordance with the techniques of this disclosure. Video encoder 20 may include in the transmitted bitstream configuration data, which may include a plurality of intra prediction mode index tables and a plurality of modified intra prediction mode index tables (also referred to as codeword mapping tables), definitions of encoding contexts for various blocks, and indications of a most probable intra prediction mode, an intra prediction mode index table, and a modified intra prediction mode index table to use for each of the contexts.

After prediction processing unit 41 generates the predictive block for the current video block via either inter prediction or intra prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block for prediction of other video blocks. Motion compensation unit 44 and/or IBC unit 48 may calculate a reference block by adding the residual block to a predictive block of one of the reference pictures within one of the reference picture lists. Motion compensation unit 44 and/or IBC unit 48 may also apply one or more interpolation filters to the reconstructed residual block to calculate sub-integer pixel values for use in motion estimation.

Summer 62 adds the reconstructed residual block to the motion compensated prediction block produced by motion compensation unit 44 to produce a reference block for storage in decoded picture buffer 64. The reference block may be used by IBC unit 48, motion estimation unit 42 and motion compensation unit 44 as a reference block to inter predict a block in a subsequent video frame or picture.

Video encoder 20 of FIG. 3 represents an example of a video encoder configured to determine a POC value for a current picture of the multi-layer video data, determine a POC value for a reference picture of the current picture, determine a layer ID value for the current picture, and determine a layer ID value for the reference picture. Based on the POC value for the current picture, the POC value for the reference picture of the current picture, the layer ID value for the current picture, and the layer ID value for the reference picture, video encoder 20 conditionally generates, for inclusion in an encoded bitstream of the multi-layer video data, a flag indicating whether weighted prediction is enabled or disabled. To conditionally generate the flag, video encoder 20 generates the flag in response to at least one of two conditions being true and does not generate the flag in response to the two conditions being false. The two conditions are (1) the POC value of the current picture is not equal to the POC value of the reference picture, and (2) the layer ID value for the current picture is not equal to the layer ID value for the reference picture. Based on the two conditions, video encoder 20 outputs an encoded bitstream of multi-layer video data.

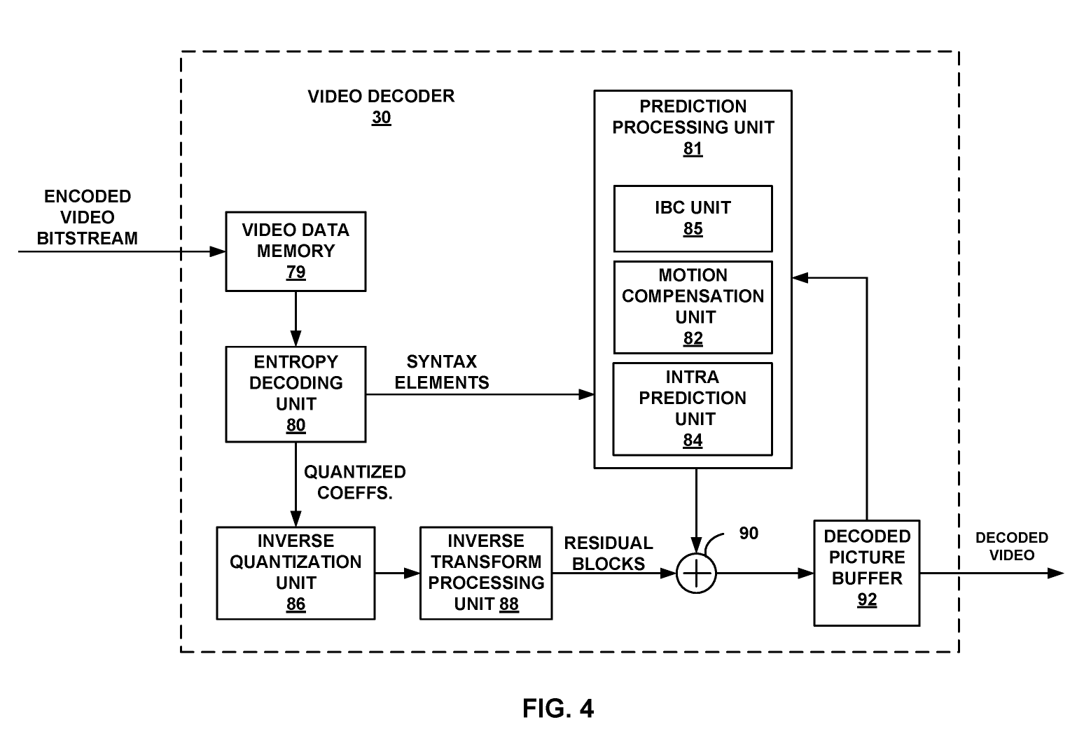

FIG. 4 is a block diagram illustrating an example video decoder 30 that may implement the techniques for IBC mode described in this disclosure. In the example of FIG. 4, video decoder 30 includes video data memory 79, entropy decoding unit 80, prediction processing unit 81, inverse quantization unit 86, inverse transform processing unit 88, summer 90, and decoded picture buffer 92. Prediction processing unit 81 includes IBC unit 85, motion compensation unit 82 and intra prediction processing unit 84. Video decoder 30 may, in some examples, perform a decoding pass generally reciprocal to the encoding pass described with respect to video encoder 20 from FIG. 3.

In various examples, a unit of video decoder 30 may be tasked to perform the techniques of this disclosure. Also, in some examples, the techniques of this disclosure may be divided among one or more of the units of video decoder 30. For example, IBC unit 85 may perform the techniques of this disclosure, alone, or in combination with other units of video decoder 30, such as motion compensation unit 82, intra prediction processing unit 84, and entropy decoding unit 80. In some examples, video decoder 30 may not include IBC unit 85 and the functionality of IBC unit 85 may be performed by other components of prediction processing unit 81, such as motion compensation unit 82.

Video data memory 79 may store video data, such as an encoded video bitstream, to be decoded by the components of video decoder 30. The video data stored in video data memory 79 may be obtained, for example, from storage device 32, from a local video source, such as a camera, via wired or wireless network communication of video data, or by accessing physical data storage media. Video data memory 79 may form a coded picture buffer (CPB) that stores encoded video data from an encoded video bitstream. Decoded picture buffer 92 is one example of a decoded picture buffer (DPB) that stores reference video data for use in decoding video data by video decoder 30 (e.g., in intra or inter coding modes, also referred to as intra or inter prediction coding modes). Video data memory 79 and DPB 92 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 79 and DPB 92 may be provided by the same memory device or separate memory devices. In various examples, video data memory 79 may be on-chip with other components of video decoder 30, or off-chip relative to those components.

During the decoding process, video decoder 30 receives an encoded video bitstream that represents video blocks of an encoded video slice and associated syntax elements from video encoder 20. Entropy decoding unit 80 of video decoder 30 entropy decodes the bitstream to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra coded (I) slice, intra prediction processing unit 84 of prediction processing unit 81 may generate prediction data for a video block of the current video slice based on a signaled intra prediction mode and data from previously decoded blocks of the current frame or picture. Prediction processing unit 81 may be configured to implement the techniques of this disclosure for an IBC coding mode. When the video frame is coded as an inter coded (i.e., B or P) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in decoded picture buffer 92.

In other examples, when the video block is coded according to the IBC mode described herein, IBC unit 85 of prediction processing unit 81 produces predictive blocks for the current video block based on block vectors and other syntax elements received from entropy decoding unit 80. The predictive blocks may be within a reconstructed region within the same picture as the current video block defined by video encoder 20, and retrieved from DPB 92.

Motion compensation unit 82 and/or IBC unit 85 may determine prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra or inter prediction) used to code the video blocks of the video slice, an inter prediction slice type (e.g., B slice or P slice), construction information for one or more of the reference picture lists for the slice, motion vectors for each inter encoded video block of the slice, inter prediction status for each inter coded video block of the slice, and other information to decode the video blocks in the current video slice.

Similarly, IBC unit 85 may use some of the received syntax elements, e.g., a flag, to determine that the current video block was predicted using the IBC mode, construction information indicating which video blocks of the picture are within the reconstructed region and should be stored in DPB 92, block vectors for each IBC predicted video block of the slice, IBC prediction status for each IBC predicted video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks. As part of determining reference blocks in reference pictures, motion compensation unit 82 may also perform weighted prediction.

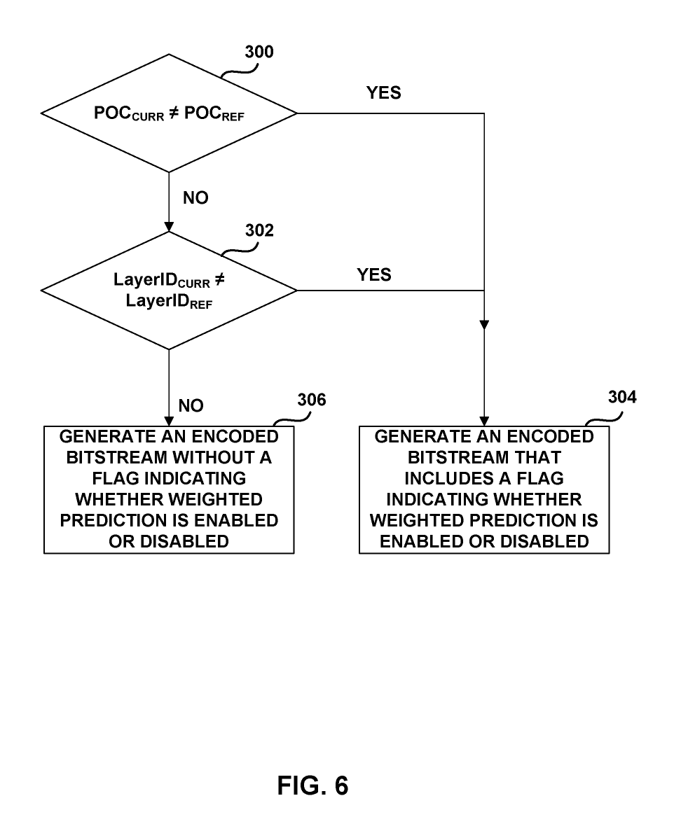

Video decoder 30 may be configured to decode blocks coded in merge mode and/or AMVP mode, which are modes for signaling inter prediction parameters, and possibly IBC parameters as well. In such cases, prediction processing unit 81 may be configured to assemble the same candidate lists assembled by video encoder 20. For example, prediction processing unit 81 may also perform the techniques described above with respect to FIGS. 6 and 7. In the example of merge mode, after assembling the merge candidate list, prediction processing unit 81 may receive a syntax element from entropy decoding unit 80 identifying an index of a candidate in the merge candidate list. IBC unit 85 and/or intra prediction processing unit 84 may locate a predictive block using the motion information associated with the selected merge candidate. If the selected merge candidate refers to the same picture as the picture that includes the block currently being decoded, then IBC unit 85 and/or intra prediction processing unit 84 may round the motion vector for the selected merge candidate to a lower a lower precision motion vector to generate a rounded version of the motion vector of the neighboring block.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After motion compensation unit 82 or IBC unit 85 generates the predictive block for the current video block based on the vectors and other syntax elements, video decoder 30 forms a decoded video block by summing the residual blocks from inverse transform processing unit 88 with the corresponding predictive blocks generated by motion compensation unit 82 and IBC unit 85. Summer 90 represents the component or components that perform this summation operation to produce reconstructed video blocks.

Summer 90 represents the component or components that perform this summation operation. An in-loop filter (not pictured) may be positioned between summer 90 and decoded picture buffer 92. The decoded video blocks in a given frame or picture are then stored in decoded picture buffer 92, which stores reference pictures used for subsequent motion compensation. Decoded picture buffer 92 also stores decoded video for later presentation on a display device, such as display device 34 of FIG. 1.

Video decoder 30 of FIG. 4 represents an example of a video decoder configured to determine a POC value for a current picture of the multi-layer video data, determine a POC value for a reference picture of the current picture, determine a layer ID value for the current picture, and determine a layer ID value for the reference picture. Video decoder 30 conditionally receives a flag (e.g., luma_weight_l0_flag, chroma_weight_l0_flag, luma_weight_l1_flag, or chroma_weight_l1_flag from Table 3 above) indicating whether weighted prediction is enabled or disabled. To conditionally receive the flag, video decoder 30 receives the flag in response to at least one of two conditions being true and does not receive the flag (e.g., skips receiving the flag) in response to both of the two conditions being false. The two conditions are (1) the POC value of the current picture is not equal to the POC value of the reference picture, and (2) the layer ID value for the current picture is not equal to the layer ID value for the reference picture. Video decoder 30 can decode a block of the multi-layer video data of the current picture based on a determination of whether weighted prediction is enabled or disabled.

Video decoder 30 may, for example, determine if the POC value of the current picture is not equal to the POC value of the reference picture by comparing the POC value for a reference picture to the current picture. Video decoder 30 may, for example, determine if the layer ID value for the current picture is not equal to the layer ID value for the reference picture by comparing the nuh_layer_id value for the current picture to a layer ID value of a reference picture.

In response to receiving the flag and the flag indicating weighted prediction is enabled, video decoder 30 receives one or more weighted prediction parameters and predicts a block of the current picture using a weighted prediction process. In response to receiving the flag and the flag indicating weighted prediction is disabled, video decoder 30 decodes the current picture without receiving one or more weighted prediction parameters. In response to not receiving the flag as a result of both conditions being false, video decoder 30 decodes the current picture without receiving one or more weighted prediction parameters.

In some example, a first value for the flag may indicate weighting and offset factors for a luma component of the current picture are present (i.e., weighted prediction is enabled), and a second value for the flag may indicate whether weighting and offset factors for the luma component of the current picture are not present (i.e, weighted prediction is disabled). In some example, a first value for the flag may indicate weighting and offset factors for a chroma component of the current picture are present (i.e., weighted prediction is enabled), and a second value for the flag may indicate whether weighting and offset factors for the chroma component of the current picture are not present (i.e, weighted prediction is disabled).

The flag described above indicating whether weighted prediction is enabled or disabled may be one of multiple flags. For example, Table 3 above shows four such flags (e.g., luma_weight_l0_flag, chroma_weight_l0_flag, luma_weight_l1_flag, and chroma_weight_l1_flag).

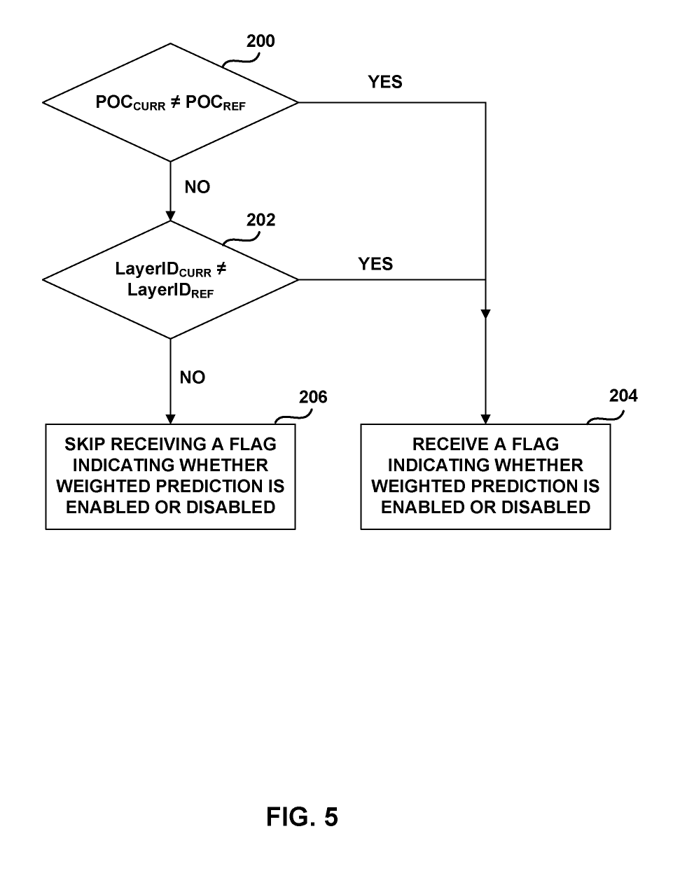

FIG. 5 is a flowchart showing a method of decoding video data in accordance with techniques of this disclosure. FIG. 5 will be described with reference to a generic video decoder for decoding multi-layer video data. Although not explicitly shown in FIG. 5, in the example of FIG. 5, the video decoder determines POC value for a current picture of the multi-layer video data and determines a POC value for a reference picture of the current picture. The video decoder also determines a layer ID value for the current picture and a layer ID value for the reference picture. The video decoder then conditionally receives a flag indicating whether weighted prediction is enabled or disabled based on the POC value for the current picture of the multi-layer video data, the POC value for the reference picture, the layer ID value for the current picture, and the layer ID value for the reference picture.

FIG. 5 shows how the video decoder conditionally receives the flag. If the POC value of the current picture is not equal to the POC value of the reference picture (200, yes path) and/or if the layer ID value for the current picture is not equal to the layer ID value for the reference picture (202, yes path), then the video decoder receives the flag indicating whether weighted prediction is enabled or disabled (204). If the POC value of the current picture is equal to the POC value of the reference picture (200, no path) and if the layer ID value for the current picture is equal to the layer ID value for the reference picture (202, no path), then the video decoder skips receiving the flag indicating whether weighted prediction is enabled or disabled (206).

If the video decoder skips receiving the flag indicating whether weighted prediction is enabled or disabled, then the video decoder implicitly disables weighted prediction. If the video decoder receives the flag indicating whether weighted prediction is enabled or disabled, then the video decoder enables or disables weighted prediction based on the value of the flag. The video decoder decodes a block of video data of the current picture based on the determination of whether weighted prediction is enabled or disabled.

FIG. 6 is a flowchart showing a method of encoding video data in accordance with techniques of this disclosure. FIG. 6 will be described with reference to a generic video encoder for encoding multi-layer video data. Although not explicitly shown in FIG. 6, in the example of FIG. 6, the video encoder determines a POC value for a current picture of the multi-layer video data and determines a POC value for a reference picture of the current picture. The video encoder also determines a layer ID value for the current picture and a layer ID value for the reference picture. The video encoder then conditionally generates a flag indicating whether weighted prediction is enabled or disabled based on the POC value for the current picture of the multi-layer video data, the POC value for the reference picture, the layer ID value for the current picture, and the layer ID value for the reference picture.

FIG. 6 shows how the video encoder conditionally generating the flag. If the POC value of the current picture is not equal to the POC value of the reference picture (300, yes path) and/or if the layer ID value for the current picture is not equal to the layer ID value for the reference picture (302, yes path), then the video encoder generates, for inclusion in an encoded bitstream of multi-layer video data, the flag indicating whether weighted prediction is enabled or disabled (304). If the POC value of the current picture is equal to the POC value of the reference picture (300, no path) and if the layer ID value for the current picture is equal to the layer ID value for the reference picture (302, no path), then the video encoder generates an encoded video bitstream without a flag indicating whether weighted prediction is enabled or disabled (306).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding multi-layer video data, the method comprising:
determining a picture order count (POC) value for a current picture of the multi-layer video data;
determining a POC value for a reference picture of the current picture;
determining a layer identification (ID) value for the current picture;
determining a layer ID value for the reference picture;
conditionally receiving a flag indicating whether weighted prediction is enabled or disabled, wherein conditionally receiving the flag comprises receiving the flag in response to at least one of two conditions being true and not receiving the flag in response to the two conditions being false, the two conditions being (1) the POC value of the current picture is not equal to the POC value of the reference picture, and (2) the layer ID value for the current picture is not equal to the layer ID value for the reference picture; and
decoding a block of the multi-layer video data of the current picture based on a determination of whether weighted prediction is enabled or disabled.

2. The method of claim 1, further comprising:
in response to receiving the flag and the flag indicating weighted prediction is enabled, receiving one or more weighted prediction parameters; and
predicting a block of the current picture using a weighted prediction process.

3. The method of claim 1, further comprising:
in response to receiving the flag and the flag indicating weighted prediction is disabled, decoding the current picture without receiving one or more weighted prediction parameters.

4. The method of claim 1, further comprising:
in response to not receiving the flag as a result of the two conditions being false, decoding the current picture without receiving one or more weighted prediction parameters.

5. The method of claim 1, wherein a first value for the flag indicating whether weighted prediction is enabled or disabled indicates weighting factors for a luma component of the current picture are present and a second value for the flag indicating whether weighted prediction is enabled or disabled indicates weighting factors for the luma component of the current picture are not present.

6. The method of claim 1, wherein the flag indicating whether weighted prediction is enabled or disabled comprises a first flag, and wherein the first flag indicates whether weighted prediction is enabled or disabled for a luma component of the current picture, the method further comprising:
conditionally receiving a second flag indicating whether weighted prediction is enabled or disabled for a chroma component of the current picture, wherein conditionally receiving the second flag comprises receiving the second flag in response to at least one of two conditions being true and not receiving the second flag in response to the two conditions being false, the two conditions being (1) the POC value of the current picture is not equal to the POC value of the reference picture, and (2) the layer ID value for the current picture is not equal to the layer ID value for the reference picture.

7. The method of claim 1, wherein the flag indicating whether weighted prediction is enabled or disabled comprises a first flag, and wherein the first flag indicates whether weighted prediction is enabled or disabled for reference pictures of a first reference picture list, the method further comprising:
conditionally receiving a second flag indicating whether weighted prediction is enabled or disabled for reference pictures of a second reference picture list, wherein conditionally receiving the second flag comprises receiving the second flag in response to at least one of two conditions being true and not receiving the second flag in response to the two conditions being false, the two conditions being (1) the POC value of the current picture is not equal to the POC value of the reference picture, and (2) the layer ID value for the current picture is not equal to the layer ID value for the reference picture.

8. The method of claim 1, further comprising:
receiving the multi-layer video data at a receiver of a wireless communication device;
storing the multi-layer video data in a memory of the wireless communication device; and
processing the multi-layer video data on one or more processors of the wireless communication device.

9. The method of claim 8, wherein the wireless communication device comprises a telephone handset and wherein receiving the multi-layer video data at the receiver of the wireless communication device comprises demodulating, according to a wireless communication standard, a signal comprising the multi-layer video data.

10. A device for decoding multi-layer video data, the device comprising:
a memory configured to store the multi-layer video data;
one or more processors configured to:
determine a picture order count (POC) value for a current picture of the multi-layer video data;
determine a POC value for a reference picture of the current picture;
determine a layer identification (ID) value for the current picture;
determine a layer ID value for the reference picture;
conditionally receive a flag indicating whether weighted prediction is enabled or disabled, wherein to conditionally receive the flag the one or more processors are further configured to receive the flag in response to at least one of two conditions being true and not receive the flag in response to the two conditions being false, the two conditions being (1) the POC value of the current picture is not equal to the POC value of the reference picture, and (2) the layer ID value for the current picture is not equal to the layer ID value for the reference picture; and
decode a block of the multi-layer video data of the current picture based on a determination of whether weighted prediction is enabled or disabled.

11. The device of claim 10, wherein the one or more processors are further conjured to:
in response to receiving the flag and the flag indicating weighted prediction is enabled, receive one or more weighted prediction parameters; and
predict a block of the current picture using a weighted prediction process.

12. The device of claim 10, wherein the one or more processors are further conjured to:
in response to receiving the flag and the flag indicating weighted prediction is disabled, decode the current picture without receiving one or more weighted prediction parameters.

13. The device of claim 10, wherein the one or more processors are further conjured to:
in response to not receiving the flag as a result of the two conditions being false, decode the current picture without receiving one or more weighted prediction parameters.

14. The device of claim 10, wherein a first value for the flag indicating whether weighted prediction is enabled or disabled indicates weighting factors for a luma component of the current picture are present and a second value for the flag indicating whether weighted prediction is enabled or disabled indicates weighting factors for the luma component of the current picture are not present.

15. The device of claim 10, wherein the flag indicating whether weighted prediction is enabled or disabled comprises a first flag, and wherein the first flag indicates whether weighted prediction is enabled or disabled for a luma component of the current picture, the, wherein the one or more processors are further conjured to:
conditionally receive a second flag indicating whether weighted prediction is enabled or disabled for a chroma component of the current picture, wherein to conditionally receive the second flag the one or more processors are further configured to receive the second flag in response to at least one of two conditions being true and not receive the second flag in response to the two conditions being false, the two conditions being (1) the POC value of the current picture is not equal to the POC value of the reference picture, and (2) the layer ID value for the current picture is not equal to the layer ID value for the reference picture.

16. The device of claim 10, wherein the flag indicating whether weighted prediction is enabled or disabled comprises a first flag, and wherein the first flag indicates whether weighted prediction is enabled or disabled for reference pictures of a first reference picture list, wherein the one or more processors are further conjured to:
conditionally receive a second flag indicating whether weighted prediction is enabled or disabled for reference pictures of a second reference picture list, wherein to conditionally receive the second flag the one or more processors are further configured to receive the second flag in response to at least one of two conditions being true and not receiving the second flag in response to the two conditions being false, the two conditions being (1) the POC value of the current picture is not equal to the POC value of the reference picture, and (2) the layer ID value for the current picture is not equal to the layer ID value for the reference picture.

17. The device of claim 10, wherein the device comprises a wireless communication device, further comprising a receiver configured to receive an encoded bitstream, comprising the multi-layer video data.

18. The device of claim 17, wherein the wireless communication device comprises a telephone handset and wherein the receiver is configured to demodulate, according to a wireless communication standard, a signal comprising the encoded bitstream.

19. An apparatus for decoding multi-layer video data, the device comprising:
means for determining a picture order count (POC) value for a current picture of the multi-layer video data;
means for determining a POC value for a reference picture of the current picture;
means for determining a layer identification (ID) value for the current picture;
means for determining a layer ID value for the reference picture;
means for conditionally receiving a flag indicating whether weighted prediction is enabled or disabled, wherein the means for conditionally receiving the flag comprises means for receiving the flag in response to at least one of two conditions being true and means for not receiving the flag in response to the two conditions being false, the two conditions being (1) the POC value of the current picture is not equal to the POC value of the reference picture, and (2) the layer ID value for the current picture is not equal to the layer ID value for the reference picture; and
means for decoding a block of the multi-layer video data of the current picture based on a determination of whether weighted prediction is enabled or disabled.

20. The apparatus of claim 19, further comprising:
means for receiving one or more weighted prediction parameters in response to receiving the flag and the flag indicating weighted prediction is enabled; and
means for predicting a block of the current picture using a weighted prediction process.

21. The apparatus of claim 19, further comprising:
means for decoding the current picture without receiving one or more weighted prediction parameters in response to receiving the flag and the flag indicating weighted prediction is disabled.

22. The apparatus of claim 19, further comprising:
means for decoding the current picture without receiving one or more weighted prediction parameters in response to not receiving the flag as a result of the two conditions being false.

23. The apparatus of claim 19, wherein a first value for the flag indicating whether weighted prediction is enabled or disabled indicates weighting factors for a luma component of the current picture are present and a second value for the flag indicating whether weighted prediction is enabled or disabled indicates weighting factors for the luma component of the current picture are not present.

24. The apparatus of claim 19, wherein the flag indicating whether weighted prediction is enabled or disabled comprises a first flag, and wherein the first flag indicates whether weighted prediction is enabled or disabled for a luma component of the current picture, the apparatus further comprising:
means for conditionally receiving a second flag indicating whether weighted prediction is enabled or disabled for a chroma component of the current picture, wherein the means for conditionally receiving the second flag comprises means for receiving the second flag in response to at least one of two conditions being true and means for not receiving the second flag in response to the two conditions being false, the two conditions being (1) the POC value of the current picture is not equal to the POC value of the reference picture, and (2) the layer ID value for the current picture is not equal to the layer ID value for the reference picture.

25. The apparatus of claim 19, wherein the flag indicating whether weighted prediction is enabled or disabled comprises a first flag, and wherein the first flag indicates whether weighted prediction is enabled or disabled for reference pictures of a first reference picture list, the apparatus further comprising:
means for conditionally receiving a second flag indicating whether weighted prediction is enabled or disabled for reference pictures of a second reference picture list, wherein the means for conditionally receiving the second flag comprises means for receiving the second flag in response to at least one of two conditions being true and means for not receiving the second flag in response to the two conditions being false, the two conditions being (1) the POC value of the current picture is not equal to the POC value of the reference picture, and (2) the layer ID value for the current picture is not equal to the layer ID value for the reference picture.

26. A computer readable storage medium storing instructions that when executed by one or more processors cause the one or more processors to:
determine a picture order count (POC) value for a current picture of the multi-layer video data;
determine a POC value for a reference picture of the current picture;
determine a layer identification (ID) value for the current picture;
determine a layer ID value for the reference picture;
conditionally receive a flag indicating whether weighted prediction is enabled or disabled, wherein to conditionally receive the flag the instructions cause the one or more processors to receive the flag in response to at least one of two conditions being true and not receive the flag in response to the two conditions being false, the two conditions being (1) the POC value of the current picture is not equal to the POC value of the reference picture, and (2) the layer ID value for the current picture is not equal to the layer ID value for the reference picture; and
decode a block of the multi-layer video data of the current picture based on a determination of whether weighted prediction is enabled or disabled.

27. The computer readable storage medium of claim 26, storing further instructions that when executed by the one or more processors cause the one or more processors to:
in response to receiving the flag and the flag indicating weighted prediction is enabled, receive one or more weighted prediction parameters; and
predict a block of the current picture using a weighted prediction process.

28. The computer readable storage medium of claim 26, storing further instructions that when executed by the one or more processors cause the one or more processors to:
in response to receiving the flag and the flag indicating weighted prediction is disabled, decode the current picture without receiving one or more weighted prediction parameters.

29. The computer readable storage medium of claim 26, further comprising:
in response to not receiving the flag as a result of the two conditions being false, decode the current picture without receiving one or more weighted prediction parameters.

30. The computer readable storage medium of claim 26, wherein a first value for the flag indicating whether weighted prediction is enabled or disabled indicates weighting factors for a luma component of the current picture are present and a second value for the flag indicating whether weighted prediction is enabled or disabled indicates weighting factors for the luma component of the current picture are not present.

31. The computer readable storage medium of claim 26, wherein the flag indicating whether weighted prediction is enabled or disabled comprises a first flag, and wherein the first flag indicates whether weighted prediction is enabled or disabled for a luma component of the current picture, the computer readable medium storing further instructions that when executed by the one or more processors cause the one or more processors to:
conditionally receive a second flag indicating whether weighted prediction is enabled or disabled for a chroma component of the current picture, wherein to conditionally receive the second flag the instructions cause the one or more processors to receive the second flag in response to at least one of two conditions being true and not receive the second flag in response to the two conditions being false, the two conditions being (1) the POC value of the current picture is not equal to the POC value of the reference picture, and (2) the layer ID value for the current picture is not equal to the layer ID value for the reference picture.

32. The computer readable storage medium of claim 26, wherein the flag indicating whether weighted prediction is enabled or disabled comprises a first flag, and wherein the first flag indicates whether weighted prediction is enabled or disabled for reference pictures of a first reference picture list, the computer readable medium storing further instructions that when executed by the one or more processors cause the one or more processors to:
conditionally receive a second flag indicating whether weighted prediction is enabled or disabled for reference pictures of a second reference picture list, wherein to conditionally receive the second flag the instructions cause the one or more processors to receive the second flag in response to at least one of two conditions being true and not receive the second flag in response to the two conditions being false, the two conditions being (1) the POC value of the current picture is not equal to the POC value of the reference picture, and (2) the layer ID value for the current picture is not equal to the layer ID value for the reference picture.

33. A method of encoding multi-layer video data, the method comprising:
determining a picture order count (POC) value for a current picture of the multi-layer video data;
determining a POC value for a reference picture of the current picture;
determining a layer identification (ID) value for the current picture;
determining a layer ID value for the reference picture;
conditionally generating, for inclusion in an encoded bitstream of the multi-layer video data, a flag indicating whether weighted prediction is enabled or disabled, wherein conditionally generating the flag comprises generating the flag in response to at least one of two conditions being true and not generating the flag in response to the two conditions being false, the two conditions being (1) the POC value of the current picture is not equal to the POC value of the reference picture, and (2) the layer ID value for the current picture is not equal to the layer ID value for the reference picture; and
outputting the encoded bitstream of multi-layer video data.

34. The method of claim 33, further comprising:
in response to generating the flag and the flag indicating weighted prediction is enabled, generating one or more weighted prediction parameters for inclusion in the encoded bitstream of multi-layer video data.

35. The method of claim 33, further comprising:
in response to not generating the flag as a result of the two conditions being false, generating the encoded video bitstream of multi-layer video data for the current picture without including one or more weighted prediction parameters.

36. The method of claim 33, wherein a first value for the flag indicating whether weighted prediction is enabled or disabled indicates weighting factors for a luma component of the current picture are present in the encoded bitstream of multi-layer video data and a second value for the flag indicating whether weighted prediction is enabled or disabled indicates weighting factors for the luma component of the current picture are not present in the encoded bitstream of multi-layer video data.

37. The method of claim 33, further comprising:
storing the multi-layer video data in a memory of a wireless communication device;
processing the multi-layer video data on one or more processors of the wireless communication device; and
transmitting an encoded bitstream comprising the multi-layer video data from a transmitter of the wireless communication device;

38. The method of claim 37, wherein the wireless communication device comprises a telephone handset and wherein transmitting the encoded bitstream at the transmitter of the wireless communication device comprises modulating, according to a wireless communication standard, a signal comprising the encoded bitstream.

39. A device for encoding video data, the device comprising:
a memory configured to store multi-layer video data;
one or more processors configured to:
determine a picture order count (POC) value for a current picture of the multi-layer video data;
determine a POC value for a reference picture of the current picture;
determine a layer identification (ID) value for the current picture;
determine a layer ID value for the reference picture;
conditionally generate, for inclusion in an encoded bitstream of the multi-layer video data, a flag indicating whether weighted prediction is enabled or disabled, wherein to conditionally generate the flag the one or more processors are configured to generate the flag in response to at least one of two conditions being true and not generate the flag in response to the two conditions being false, the two conditions being (1) the POC value of the current picture is not equal to the POC value of the reference picture, and (2) the layer ID value for the current picture is not equal to the layer ID value for the reference picture; and
output the encoded bitstream of multi-layer video data.

40. The device of claim 39, wherein the one or more processors are further configured to:
in response to generating the flag and the flag indicating weighted prediction is enabled, generate one or more weighted prediction parameters for inclusion in the encoded bitstream of multi-layer video data.

41. The device of claim 39, wherein the one or more processors are further configured to:
in response to not generating the flag as a result of the two conditions being false, generate the encoded video bitstream of multi-layer video data for the current picture without including one or more weighted prediction parameters.

42. The device of claim 39, wherein a first value for the flag indicating whether weighted prediction is enabled or disabled indicates weighting factors for a luma component of the current picture are present in the encoded bitstream of multi-layer video data and a second value for the flag indicating whether weighted prediction is enabled or disabled indicates weighting factors for the luma component of the current picture are not present in the encoded bitstream of multi-layer video data.

43. The device of claim 39, wherein the device comprises a wireless communication device, further comprising a transmitter configured to transmit an encoded bitstream comprising the multi-layer video data.

44. The device of claim 43, wherein the wireless communication device comprises a telephone handset and wherein the transmitter is configured to modulate, according to a wireless communication standard, a signal comprising the encoded bitstream.
